(19) United States
(12) Patent Application Publication
(10) Pub. No.: US 2012/0190774 A1
(43) Pub. Date: Jul. 26, 2012

(54) COMPOSITION AND METHOD FOR PRODUCING LIME SAND BRICK

(75) Inventors: Oliver Blask, Oftersheim (DE); Dieter Honert, Dielheim (DE); Olaf Kern, Altrip (DE)

(73) Assignee: SIKA TECHNOLOGY AG, Baar (CH)

(21) Appl. No.: 13/497,452

(22) PCT Filed: Sep. 21, 2010
(86) PCT No.: PCT/EP2010/063904

§ 371 Date: Apr. 11, 2012

(30) Foreign Application Priority Data
Sep. 21, 2009 (EP) 09170837.0

(51) Int. Cl. C08K 3/00; B28B 1/00

(52) U.S. Cl. 524/3; 524/5; 264/333

(57) ABSTRACT

The present invention relates to a composition for producing lime sand brick comprising lime, sand, water and at least one plasticizer, in particular a comb polymer KP having side chains bound to the main chain via ester or ether groups. The invention further relates to a method for producing lime sand brick.

### TECHNICAL FIELD

The invention relates the field of producing lime sand brick.

### BACKGROUND ART

It has been known to produce so-called lime sand bricks from a mixture of lime, sand and water, which have been proven to be effective in particular in building construction and have gained acceptance in this field. These lime sand bricks are characterized by their high density and hence their high heat storage capacity, static strength and their good sound insulation. In this method the still moldable raw material consisting of sand, lime and water is pressed in hydraulic presses under high pressure to give green bricks and is subsequently hardened in steam hardening autoclaves at temperatures of from 160° C. to 220° C. under saturated vapor pressure. In this process the hot vapor atmosphere initiates chemical processes within the lime sand brick that result in a strong interlock of the sand bodies.

According to the current state of the art, the mold pressure acting on the green lime sand bricks is increased and/or the grain size distribution of the aggregate is optimized and/or heavy aggregates, typically basalt, are added in order to improve the product quality of the lime sand bricks, in particular the bulk density being tested and the compression strength.

However, increasing the applied mold pressure results in increased wear of the pressing tools and an increased expenditure of energy. Optimizing the grain size distribution can only be achieved by additionally purchasing and transporting suitable sands which is a considerable economic disadvantage since most lime sand brick producers have sand pits belonging to the firm. Heavy aggregates such as basalt are disadvantageous in that they often have to be purchased in addition and are expensive.

Further, above a certain height of the lime sand bricks the mold pressure of the hydraulic presses is no longer sufficient to achieve a sufficient pressing in the middle of the green brick, which has a negative effect on the bulk density being tested and the compression strength of the finished lime sand brick.

### DISCLOSURE OF THE INVENTION

On this basis, it is the object of the present invention to provide a lime sand brick that requires a lower expenditure of energy for pressing and results in a higher product quality over the prior art.

Surprisingly, it has now been found that a composition for producing lime sand brick comprising lime, sand, water and at least one plasticizer results in improved processability of the composition in the uncured state. Since plasticizers are typically used in cementitious compositions having a water content of 35-60% by weight of the binder, an improvement of processability in compositions for producing lime sand brick having a water content of, typically, only 1-10% by weight, temporarily of up to 25% by weight, is surprising.

The composition according to the invention allows to achieve desired bulk densities being tested in the production of lime sand bricks employing less press cycles, with consequent beneficial effects on the energy required, the production time and the wear of the pressing tools. Further, reducing the required mold pressure allows the use of less powerful and hence less expensive pressing machines and molds.

Moreover, it has surprisingly been found that the increased plasticity of the composition according to the invention improves the fitting accuracy and allows to realize more complicated forms of green pressed articles.

Moreover, the composition according to the invention allows the amount of lime to be reduced, which results in an increase of the compression strength and the bulk density being tested.

In the present document, the term “bulk density being tested” is understood as the density of a green lime sand brick after pressing and hydrothermal treatment.

Further, it has been found that even very large molded bodies made from compositions according to the invention have a higher compaction and thus a higher compression strength after pressing than conventional compositions.

Moreover, it has surprisingly been found that the additional use of a surfactant further reduces the required pressing cycles and thus further improves the product quality of the lime sand bricks, namely the bulk density being tested and the compression strength.

Other aspects of the invention are the subject matter of additional independent claims. Especially preferred embodiments of the invention are the subject matter of the dependent claims.

### WAYS OF CARRYING OUT THE INVENTION

The present invention relates to a composition for producing lime sand brick comprising lime, sand, water and at least one plasticizer.

In the present document, the term “lime sand brick” is understood as molded bodies made from a mixture of lime and sand by compressing, molding and hardening under saturated vapor pressure, typically at temperatures of 160-220° C. (hydrothermal hardening) for 4-12 hours.

In the present document, the term “lime” is understood as calcium hydroxide (hydrated lime, Ca(OH)₂), which is typically obtained by the exothermic reaction of calcium oxide (burnt lime, CaO) with water,

In the present document, the term “sand” is understood as mineral clastic sediments (clastic rocks) which are loose conglomerates (loose sediments) of round or angular small grains predominantly having diameters of 0.06-4 mm which were detached from the original grain structure during the mechanical and chemical degradation and transported to their deposition point, said sediments having an SiO₂ content of greater than 50% by weight, in particular greater than 75% by weight, particularly preferred greater than 85% by weight.

Typically, suitable sand is quartz sands consisting of more than 85% by weight, in particular more than 90% by weight of quartz.

In the present document, the term “plasticizer” is understood as additives that improve the processability and flow properties of mineral compositions, in particular of compositions for producing lime sand brick or reduce the required water content.

Suitable plasticizers are plasticizers selected from the list consisting of lignin sulfonate, sulfonated melamine-formaldehyde condensate, sulfonated naphthalene-formaldehyde condensate and comb polymers KP having side chains bound to the main chain via ester or ether groups.

Preferably, the at least one plasticizer is a comb polymer KP having side chains bound to the main chain via ester or ether groups.

A comb polymer consists of a linear polymer chain (=main chain) having side chains bound via ester or ether groups. Figuratively speaking, the side chains form the “teeth” of a “comb”.

Suitable comb polymers KP are, on the one hand, comb polymers having side chains bound to the linear polymer backbone via ether groups.

Side chains bound to the linear polymer backbone via ether groups can be introduced by polymerizing vinyl ethers or allyl ethers.

Such comb polymers have been disclosed, for example, in WO 2006/133933 A2, the contents of which is hereby incorporated by reference. The vinyl ethers or allyl ethers have, in particular, the formula (H).

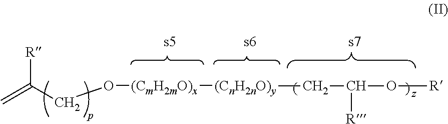

Here, R′ represents H or an aliphatic hydrocarbon moiety having from 1 to 20 C atoms or a cycloaliphatic hydrocarbon moiety having from 5 to 8 C atoms or an optionally substituted aryl moiety having from 6 to 14 C atoms. R″ represents H or a methyl group and R″' represents an unsubstituted or substituted aryl moiety, in particular a phenyl moiety.

Further, p represents 0 or 1; m and n each independently of each other represent 2, 3 or 4; and x and y and z each independently of each other represent values ranging from 0 to 350.

The sequence of the partial structural elements designated as s5, s6 and s7 in formula (II) can be distributed in an alternating, block-like or random manner.

In particular, such comb polymers are copolymers of vinyl ethers or allyl ether with maleic anhydride, maleic acid and/or (meth)acrylic acid.

Suitable comb polymers KP are, on the other hand, comb polymers having side chains bound to the linear polymer backbone via ester groups. This kind of comb polymer KP is preferred over the comb polymers having side chains bound to the linear polymer backbone via ether groups.

Especially preferred comb polymers KP are copolymers of the formula (I).

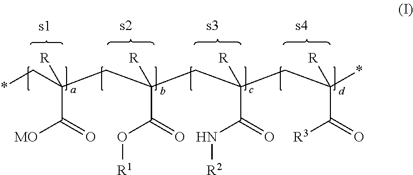

Here, M independently of each other represent H⁺, an alkali metal ion, an alkaline earth metal ion, a di- or trivalent metal ion, an ammonium ion or an organic ammonium group. In the present document, the term “independently of each other” in each case means that a substituent may have various available meanings in the same molecule. Thus, for example, the copolymer of the formula (I) can comprise carboxylic acid groups and sodium carboxylate groups at the same time, which means that, in this case, M represents H⁺ and Na⁺ independently of each other.

It is clear to the skilled person that, on the one hand, said copolymer is a carboxylate to which the ion M is bound and, on the other hand, the charge of multivalent ions M must be compensated by counterions.

Moreover, the substituents R independently of each other represent hydrogen or a methyl group.

Moreover, the substituents R¹ independently of each other represent -[AO]_{q}—R⁴. The substituents R² independently of each other represent a C₁ to C₂₀ alkyl group, cycloalkyl group, alkylaryl group or -[AO]_{q}—R⁴. In both cases the substituents A independently of each other represent a C₂ to C₄ alkylene group and R⁴ represents a C₁ to C₂₀ alkyl group, cyclohexyl group or alkylaryl group and q has a value of from 2 to 250, in particular from 8 to 200, especially preferred from 11 to 150.

Further, the substituents R³ independently of each other represent —NH₂, —NR⁵R⁶, —OR⁷NR⁶R⁹. Here, R⁵ and R⁶ independently of each other represent a C₁ to C₂₀ alkyl group, cycloalkyl group or alkylaryl group or aryl group or a hydroxyalkyl group or an acetoxyethyl (CH₃—CO—O—CH₂—CH₂—) or a hydroxyisopropyl- (HO—CH(CH₃)—CH₂—) or an acetoxyisopropyl group (CH₃—CO—O—CH(CH₃)—CH₂—); or R⁵ and R⁶ together form a ring wherein the nitrogen is one member forming a morpholine or imidazoline ring.

The substituent R⁷ represents a C₂-C₄ alkylene group.

Moreover, the substituents R⁸ and R⁹ each independently of each other represent a C₁ to C₂₀ alkyl group, cycloalkyl group, alkylaryl group, aryl group or a hydroxyalkyl group.

The sequence of the partial structural elements designated as s1, s2, s3 and s4 in formula (I) can be distributed in an alternating, block-like or random manner.

Finally, the indices a, b, c and d are molar ratios of the structural units s1, s2, s3 and s4. These structural elements have a ratio to each other of:

a/b/c/d=(0.1-0.9)/(0.1-0.9)/(0-0.8)/(0-0.3),

in particular a/b/c/d=(0.1-0.9)/(0.1-0.9)/(0-0.5)/(0-0.1),

preferably a/b/c/d=(0.1-0.9)/(0.1-0.9)/(0-0.3)/(0-0.06)

provided that a+b+c+d=1. The sum c+d is preferably greater than 0.

The comb polymer KP of the formula (I) can be produced, on the one hand, by a free radical polymerization of the corresponding monomers of the formulas (IIIₐ), (III_{b}), (III_{c}) and (III_{d}) which yields the structural units s1, s2, s3 and s4,

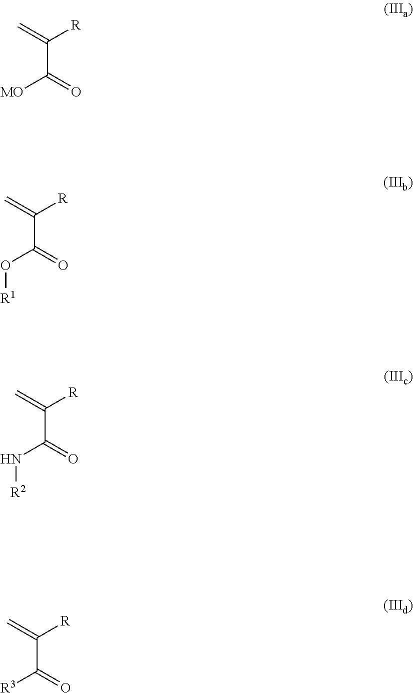

or, on the other hand, by a so-called polymer-analogous reaction of a polycarboxylic acid of the formula (IV)

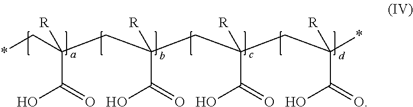

In the polymer-analogous reaction the polycarboxylic acid of the formula (IV) is esterified or amidated with the corresponding alcohols or amines and subsequently eventually neutralized or partially neutralized (depending on the type of moiety M, e.g., with metal hydroxides or ammonia). Details of the polymer-analogous reaction have been disclosed, for example, in EP 1,138,697 B1 from page 7, line 20, to page 8, line 50, and the examples or in EP 1,061,089 B1 from page 4, line 54 to page 5, line 38 and the examples. In a modification thereof described in EP 1,348,729 A1 from page 3 to page 5 and the examples, the comb polymer KP of the formula (I) can be produced in the solid state. The disclosure of the above-mentioned patents is hereby incorporated by reference.

It has been found that the comb polymers KP of the formula (I) with c+d>0, in particular d>0 are an especially preferred embodiment. In particular, —NH—CH₂—CH₂—OH has been found to be a particularly advantageous moiety R³.

The comb polymers KP that are commercially available under the trade name series ViscoCrete® from the company Sika Schweiz AG have proven to be especially suited.

Further, it is advantageous if the composition additionally contains at least one surfactant.

In the present document, the term “surfactant” is understood as surface tension lowering substances. However, the term does not include the above-mentioned plasticizers.

Typically, surfactants are classified according to the type and charge of the hydrophilic molecular portion. Four hydrophilic groups can be distinguished: anionic surfactants, cationic surfactants, nonionic surfactants and amphoteric surfactants.

Anionic surfactants typically have one or several functional anion-active groups that dissociate in water to form anions which are ultimately responsible for the surface-active properties. Examples of typical surface-active groups are: —COONa, —SO₃Na, —OSO₃Na that render the soaps and alkylarene sulfonates (e.g., dodecylbenzene sulfonate) and the alkane sulfonates, a-olefin sulfonates and alkyl sulfates the most important anionic surfactants.

Suitable anionic surfactants are selected from the group consisting of fatty alcohol sulfates, e.g., buryl sulfate or lauryl myristyl sulfates; ether sulfates; olefin/paraffin sulfonates; alkyl sulfonates; alkylbenzene sulfonates; sulfosuccinates, e.g., dioctyl sulfosuccinates, dilaureth sulfosuccinate or C12-C14 alcohol polyglycol ether sulfosuccinate; and phosphoric acid esters.

Cationic surfactants are almost exclusively characterized by the presence of a quaternary ammonium group. Cationic surfactants wherein the nitrogen group is substituted by two long and two short alkyl moieties, e.g., dimethyl distearyl ammonium chloride, are of special importance.

Usually, nonionic surfactants are produced by ethoxylating compounds having active hydrogen atoms; of these, the addition products of ethylene oxide and fatty alcohols or oxo alcohols are of the greatest significance. Further, ethoxylates of alkyl phenols, the alkylphenol polyglycol ethers, block polymers of ethylene and propylene oxide (EO/PO block polymers) and alkyl glycosides are common.

Suitable nonionic surfactants are selected from the group consisting of alcohol ethoxylates which are commercially available, for example, under the trade name Berol® 260 or Berol® 840; polyalkylene glycol ethers, also referred to as fatty alcohol ethoxylates, such as polyoxyethylene stearyl ethers, polyoxyethylene lauryl ethers or polyoxyethylene cetyl ethers, of which some are available under the trade names Brij®, Genapol® or Lutensol®; fatty alcohol propoxylates; EO/PO block polymers such as Jeffox® WL-600; polypropylene glycols such as, e.g., the members of the Pluriol® P trade marks; polyethylene glycols; alkyl glucosides such as, e.g., Tween® 20; alkyl polyglycosides; octylphenol ethoxylates such as, e.g., Triton X-100; and nonylphenol ethoxylates such as, e.g., Nonoxinol-9.

Preferred nonionic surfactants are nonionic surfactants selected from the group consisting of fatty alcohol ethoxylates and EO/PO block polymers.

Especially preferably, the at least one surfactant is a nonionic surfactant.

Further, the at least one surfactant is preferably a low-foaming surfactant having a high wetting action. When released into the waste water via the condenser water of an autoclave, foam-forming surfactants can represent a significant source of environmental impact even after waste water treatment, for example, because they form foam in water bodies.

The composition may contain additional components. Preferably, the composition may further contain aggregates, in particular basalt, typically 5-50% by weight, based on the total weight of the composition. Examples of additional components are solvents or additives known in lime sand brick technology, in particular preservatives, heat and light stabilizers, colorants and defoamers.

In a preferred composition:
the amount of sand is 60-96.5, in particular 80-94% by weight;
the amount of lime is 3-15, in particular 4-10% by weight;
the amount of water is 0.485-25, in particular 1-15, preferably 1-10% by weight;
the amount of plasticizer is 0.015-0.5, preferably 0.018-0.2% by weight;
and, if present, the amount of surfactant is 0.00003-0.1, in particular 0.0003-0.015, preferably 0.0003-0.009% by weight;
   based on the total weight of the composition.

In another aspect, the present invention pertains to a method for producing lime sand brick comprising the steps of:
i) providing a composition described as suitable and preferred composition hereinbefore;
ii) feeding the composition to at least one pressing device and pressing;
iii) hardening the composition.

Typically, the composition of step i) is provided by mixing sand, CaO, water, plasticizer and, if used, the surfactant.

The components are preferably mixed in a horizontal mixer before storing the mixture, typically, in a storage tank for a short time until the conversion of CaO to Ca(OH)₂ is completed to a large extent. Thereafter, the composition thus obtained can be pressed.

Preferably, step i) yields a free-flowing substance that contains sand, lime, water, plasticizer and, if present, the surfactant in an evenly distributed form.

A device generally used for compacting and/or molding, typically hydraulic presses, can be used for the pressing of step ii).

Preferably, the applied mold pressure ranges from 10-25 N/mm², especially preferred from 15-20 N/mm².

If desired, the compositions can be processed to molded bodies of any geometric shape, in particular blocks, bricks, L-shaped ceiling edge blocks for ceiling edge shuttering, U-shaped open-end blocks or so-called vertically perforated bricks, etc. Moreover, the brick typically has one of the usual formats of from 1 DF to 20 DF according to DIN V 106. Preferably, molded bodies having dimensions ranging from 5 to 50 cm (length)×5 to 50 cm (width)×5 to 100 cm (height) are produced.

Preferably, step ii) yields molded bodies that can be transported or stacked immediately after step ii) without losing their shape or crumbling.

The hardening of step iii) is preferably a hydrothermal treatment that takes place at a temperature of from 160-220° C., in particular from 180-200° C. under saturated vapor pressure. Hardening typically takes from 4-12, in particular from 7-9 hours.

In the present document, the term “saturated vapor pressure” is to be understood as the pressure of the vapor phase of water in a closed system where the liquid and the vapor phase of water are at equilibrium. During hardening, the saturated vapor pressure is typically from 10-16 bar. Step iii) preferably results in molded bodies having a compression strength according to DIN V 106 of 12.5-35 N/mm².

Typically, the method is carried out in the following sequence; step i) followed by step ii) followed by step iii).

A method wherein:
the provided components of the composition are fed to a mixing device via at least one metering device and mixed;
the mixed components are fed to at least one pressing device and pressed;
the pressed composition is hardened at a temperature of 160-220° C. under saturated vapor pressure
   is a suitable embodiment.

The method according to the invention now allows to drastically reduce the expenditure of energy and time as well as the wear of the pressing tools and to improve the product quality of the resulting lime sand bricks, in particular the bulk density being tested and the compression strength.

In another aspect, the present invention pertains to a solidified composition, in particular a molded body obtainable by the above-described method. Further, in another aspect the present invention pertains to the use of an above-described composition for producing lime sand bricks.

### EXAMPLES

Used Additives

PCE 1, ViscoCrete ® Polymer PC-2, comb polymer, Sika Schweiz AG,
Switzerland
PCE 2, ViscoCrete ® Polymer RMC-2, comb polymer, Sika Schweiz AG,
Switzerland
PCE 3, Cemerol R-750 MC, comb polymer, Sika Schweiz AG, Switzerland
NT1, C12-C16 alkyl alcohol ethoxylate, nonionic surfactant
NT2, polyoxyalkylene alkyl ether fatty acid ester, nonionic surfactant
AT, mixture of sulfosuccinate and fatty alcohol sulfonate, anionic surfactant
TBP, tributyl phosphate, defoamer, Sigma-Aldrich Chemie GmbH,
Switzerland

TABLE 1
additive (ZM) composition

| Additives | ZM1 | ZM2 | ZM3 | ZM4 | ZM5 | ZM6 |
|---|---|---|---|---|---|---|
| Plasticizers: | | | | | | |
| PCE 1 | | | 60.00 | | | 15.00 |
| PCE 2 | | | | 60.00 | | |
| PCE 3 | | | | | 83.30 | |
| Surfactant: | | | | | | |
| AT | | 29.00 | | | | |
| NT1 | 10.00 | | | | | 2.50 |
| NT2 | | | | | 0.20 | |
| Defoamer | 0.16 | | 0.50 | 0.50 | | 0.04 |
| Preservative | 0.50 | 0.20 | 0.20 | 0.20 | 0.20 | 0.20 |
| Water | 89.34 | 70.80 | 39.30 | 39.30 | 16.30 | 82.26 |

Comparative examples V1 to V6 and compositions Z1 to Z8 according to the invention were provided by dry-mixing sand (and optionally basalt as heavy aggregate) and Ca(OH)₂ in a Hobart mixer for 60 seconds. The mixing water was added to the sand/Ca(OH)₂ within 15 seconds and the mixture was mixed for 120 seconds. In the case of adding additive (ZM), the additive was mixed with the mixing water for 120 seconds before adding the mixing water to the sand/Ca(OH)₂ mixture. Thereafter, the mixture was pressed.

When carrying out the examples, dispensing with the conversion of CaO to Ca(OH)₂ by directly using Ca(OH)₂ instead of CaO allowed an easier and faster handling.

### Example 1

Comparative examples V1 to V3 and compositions Z1 to Z5 according to the invention were prepared by using 53.5% by weight of sand, 35.9% by weight of basalt, 9.4% by weight of Ca(OH)₂ and 1.2% by weight of water, based on the total weight of the prepared compositions according to the invention or the comparative examples. The used basalt had a maximum particle size of 2 mm. In the case of the addition of an additive (see Table 2) to the overall composition, the respective % by weight of additive were subtracted from the sand. Thus, in the case of 0.3% by weight of the used additive, 53.2% by weight instead of 53.5% by weight of sand were used. Sand, Ca(OH)₂, water and any additive were mixed as described above.

The mixtures of the compositions according to the invention and the comparative examples were pressed with a mechanical press, thus obtaining test samples of 24 cm (length)×11.5 cm (width)×6 cm (height). Subsequently, the test samples were hardened in an autoclave under saturated vapor pressure. Thereafter, the test samples were dried at 105° C., the bulk density being tested (PRD in kg/dm³) was calculated and the compression strength (DF in N/mm²) of 2½ stacked test samples each was determined.

Table 2 shows that the compositions according to the invention attain a significantly higher compression strength compared to the comparative examples having the same bulk density being tested, which further indicates a significantly better and more uniform compressibility.

TABLE 2
compression strength (DF) and bulk density being tested
(PRD) of comparative examples V1 to V3 and compositions
Z1 to Z5 according to the invention.

| | ZM | DF | PRD |
|---|---|---|---|
| | (% by weight) | N/mm² | (kg/dm³) |
| V1 | — | 37.8 | 2.1 |
| V2 | ZM1 (0.3) | 34.2 | 2.1 |
| V3 | ZM2 (0.3) | 37.8 | 2.1 |
| Z1 | ZM3 (0.1) | 38.1 | 2.1 |
| Z2 | ZM4 (0.1) | 38.6 | 2.1 |
| Z3 | ZM4 (0.2) | 45.0 | 2.1 |
| Z4 | ZM5 (0.1) | 40.5 | 2.1 |
| Z5 | ZM6 (0.3) | 45.0 | 2.1 |

### Example 2

Comparative examples V4 to V6 and compositions Z6 to Z8 according to the invention were prepared by using sand, Ca(OH)₂, water and optionally additives in the amounts in % by weight indicated in table 3, based on the total weight of the prepared compositions according to the invention or the comparative examples. The sand consisted of 20% by weight of natural sand having a maximum particle size of 1 mm, 40.5% by weight of natural sand having a maximum particle size of 3 mm and 39.5% by weight of crushed sand having a maximum particle size of 2 mm, based on the total weight of the used sand. The mixing of sand, Ca(OH)₂, water and the addition of any additive were performed as described above.

TABLE 3
contents of comparative examples V4 to V6 and compositions
Z6 to Z8 according to the invention.

| | V4 | Z6 | V5 | Z7 | V6 | Z8 |
|---|---|---|---|---|---|---|
| Sand (% | 90.9 | 90.6 | 91.7 | 91.4 | 90.9 | 90.6 |
| by weight) | | | | | | |
| Ca(OH)₂ | 7.9 | 7.9 | 7.1 | 7.1 | 7.9 | 7.9 |
| (% by | | | | | | |
| weight) | | | | | | |
| ZM | — | 0.3 | — | 0.3 | — | 0.3 |
| (% by | | (ZM6) | | (ZM6) | | (ZM6) |
| weight) | | | | | | |
| Water | 1.2 | 1.2 | 1.2 | 1.2 | 1.2 | 1.2 |
| (% by | | | | | | |
| weight) | | | | | | |

The mixtures of the compositions according to the invention and the comparative examples were pressed with a gyratory compactor (Gyratory Compactor ICT-100R from Invelop Oy, Finland), thus obtaining cylindrical test samples having diameters of 100 mm.

The material being mixed was compressed using a rotation angle of 40 mrad and a constant pressure of 4.5 bar and thus compacted. During this operation the height of the test sample is measured with each revolution (cycle).

This compacting operation can be stopped after a certain number of rotations or when reaching a certain sample height. In the latter case, the added amount of material being mixed and the defined height allow to adjust any bulk density. In the case of a certain number of rotations, the bulk density (bulk density before autoclaving) is calculated by the sample height attained. The faster a mixture reaches a specified sample height, the better is its compressibility.

The test samples were hardened in an autoclave under saturated vapor pressure. Thereafter, the test samples were stored at 20° C. and a relative humidity of 65% and the compression strength was tested according to DIN 18501 (unpolished) at a rate of loading of 3.9 kN/s.

As shown in table 4, in the case of comparative examples V4 and V5 and compositions Z6 and Z6 according to the invention, the compacting operation was stopped when a specified sample height was reached and the number of required rotations was determined.

It can be seen from table 4 that the compositions according to the invention reach the specified bulk density after significant less cycles.

TABLE 4
compression strength (DF), bulk density before autoclaving
(RD b.A.) and bulk density being tested (PRD) of comparative examples
V4 and V5 and compositions Z6 and Z7 according to the invention.

| | ZM | Ca(OH)₂ | RD b.A. | PRD | |
|---|---|---|---|---|---|
| | (% by weight) | (% by weight) | (kg/dm³) | (kg/dm³) | Cycles |
| V4 | — | 7.9 | 2.00 | 1.93 | 65 |
| Z6 | ZM6 (0.3) | 7.9 | 2.00 | 1.93 | 27 |
| V5 | — | 7.1 | 2.00 | 1.92 | 57 |
| Z7 | ZM6 (0.3) | 7.1 | 2.00 | 1.93 | 22 |

As shown in table 5, in the case of comparative example V6 and the composition Z8 according to the invention, the compacting operation was stopped after a specified number of 60 rotations.

It can be seen from Table 5 that the composition according to the invention has a significantly higher bulk density being tested and compression strength, compared to the comparative example after the same number of cycles.

TABLE 5
compression strength (DF) and bulk density being tested
(PRD) of comparative example V6 and composition Z8
according to the invention.

| | ZM | Ca(OH)₂ | DF | PRD | |
|---|---|---|---|---|---|
| | (% by weight) | (% by weight) | (N/mm²) | (kg/dm³) | Cycles |
| V6 | — | 7.9 | 16.8 | 1.89 | 60 |
| Z8 | ZM6 (0.3) | 7.9 | 28.9 | 2.02 | 60 |

1. A composition for producing lime sand brick comprising lime, sand, water and at least one plasticizer.

2. The composition according to claim 1, wherein the at least one plasticizer is a comb polymer KP having side chains bound to the main chain via ester or ether groups.

3. The composition according to claim 2, wherein the comb polymer KP is a copolymer of the formula (I) 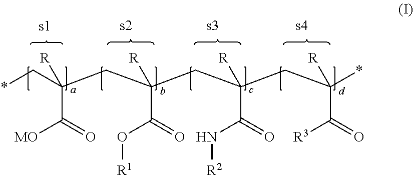
wherein
M independently of each other represent H+, an alkali metal ion, an alkaline earth metal ion, a di- or trivalent metal ion, an ammonium ion or an organic ammonium group;
each R independently of the other moieties R in formula (I) represents hydrogen or a methyl group;
R¹ independently of each other represent -[AO]_{q}—R⁴;
R2 independently of each other represent a C₁ to C₂₀ alkyl group, cycloalkyl group, alkylaryl group or -[AO]_{q}—R⁴,
wherein A represents a C₂ to C₄ alkylene group and R⁴ a C₁ to C₂₀ alkyl group, cyclohexyl group or alkylaryl group;
and q=2-250;
R³ independently of each other represent —NH₂, —NR⁵R⁶ or —OR⁷NR⁸R⁹,
wherein R⁵ and R⁶ independently of each other
represent a C₁ to C₂₀ alkyl group, a cycloalkyl group or alkylaryl group or aryl group;
or
a hydroxyalkyl group,
or an acetoxyethyl (CH₃—CO—O—CH₂—CH₂—) or a hydroxyisopropyl (HO—CH(CH₃)—CH₂—) or an acetoxyisopropyl group (CH₃—CO—O—CH(CH₃)—CH₂—),
or R⁵ and R⁶ together form a ring wherein the nitrogen is one member forming a morpholine or imidazoline ring;
wherein R⁷ represents a C₂-C₄ alkylene group;
and R⁸ and R⁹ each independently of each other represent a C₁ to C₂₀ alkyl group, cycloalkyl group, alkylaryl group, aryl group or a hydroxyalkyl group
and wherein a, b, c and d are molar ratios of the structural units s1, s2, s3 and s4
and a/b/c/d=(0.1-0.9)/(0.1-0.9)/(0-0.8)/(0-0.3) provided that a+b+c+d=1.

4. The composition according to claim 1, wherein the composition further contains at least one surfactant.

5. The composition according to claim 4, wherein the at least one surfactant is a nonionic surfactant.

6. The composition according to claim 1, wherein
the amount of sand is 60-95.5% by weight;
the amount of lime is 3-15% by weight;
the amount of water is 0.485-25% by weight;
the amount of plasticizer is 0.015-0.5% by weight;
and, if present, the amount of surfactant is 0.00003-0.1% by weight;
based on the total weight of the composition.

7. A method for producing lime sand brick comprising the steps of:
i) providing a composition according to claim 1;
ii) feeding the composition to at least one pressing device and pressing;
iii) hardening the composition.

8. The method of claim 7, wherein the hardening takes place at a temperature of 160-220° C. under saturated vapor pressure.

9. A lime sand brick obtained by the method according to claim 7.

10. (canceled)
